(19) United States
(12) Patent Application Publication
(10) Pub. No.: US 2024/0222656 A1
(43) Pub. Date: Jul. 4, 2024

(54) Battery

(71) Applicant: Standard Energy Inc., Yuseong-gu (KR)

(72) Inventors: Dongyoung LEE, Yuseong-gu (KR); Sang-Hyun Park, Yuseong-gu (KR)

(21) Appl. No.: 18/392,910

(22) Filed: Dec. 21, 2023

(30) Foreign Application Priority Data
Dec. 30, 2022 (KR) 1020220190427

(51) Int. Cl. H01M 8/0273; H01M 4/36; H01M 8/18

(52) U.S. Cl. CPC H01M 8/0273; H01M 4/368; H01M 8/188

(57) ABSTRACT

A battery can include a first current collector; a second current collector spaced apart from the first current collector; a separating membrane disposed between the first current collector and the second current collector; a frame that forms a first electrode reservoir between the first current collector and the separating membrane, and forms a second electrode reservoir between the second current collector and the separating membrane; a first adhesive member that provides a binding between the first current collector and the frame; a second adhesive member that provides a binding between the second current collector and the frame; and an inter-electrode communication part configured to allow the first electrode reservoir and the second electrode reservoir to be in fluidic communication with each other. At least part of the inter-electrode communication part can be enclosed by the first adhesive member and the frame or by the second adhesive member and the frame.

### CROSS-REFERENCE TO RELATED APPLICATION

This application claims priority to and the benefit of Korean Patent Application No. 10-2022-0190427, filed on Dec. 30, 2022, the disclosure of which is incorporated herein by reference in its entirety.

### TECHNICAL FIELD

The present disclosure relates to a battery, more particularly, a battery in which a metal ion dissolved in an electrolyte is oxidized and reduced to charge or discharge the battery.

### BACKGROUND

A redox flow battery (RFB) is a system charged or discharged by oxidizing and reducing active materials in electrolytes, and the redox flow battery is operated by continuously circulating the electrolyte inside a stack using a fluid pump, where the actual electrochemical reaction occurs in the stack.

### SUMMARY

In one aspect, a battery according to an implementation can include a first current collector; a second current collector spaced apart from the first current collector; a separating membrane disposed between the first current collector and the second current collector; a frame that forms a first electrode reservoir between the first current collector and the separating membrane, and forms a second electrode reservoir between the second current collector and the separating membrane; a first adhesive member that provides a binding between the first current collector and the frame; a second adhesive member that provides a binding between the second current collector and the frame: and an inter-electrode communication part configured to allow the first electrode reservoir and the second electrode reservoir to be in fluidic communication with each other. At least part of the inter-electrode communication part can be enclosed by the first adhesive member and the frame or by the second adhesive member and the frame.

In another aspect, a battery according to an implementation can include a first current collector; a second current collector spaced apart from the first current collector; a separating membrane disposed between the first current collector and the second current collector; a frame that forms a first electrode reservoir between the first current collector and the separating membrane and forms a second electrode reservoir between the second current collector and the separating membrane; a first adhesive member that provides a binding between the first current collector and the frame; a second adhesive member that provides a binding between the second current collector and the frame: and an inter-electrode communication part that allows the first electrode reservoir and the second electrode reservoir to communicate with each other. At least part of the first adhesive member and the second adhesive member can be disposed further toward an outer boundary of the frame, in an in-plane direction the frame, as compared to the inter-electrode communication part.

In another aspect, a battery according to an implementation can include a first liquid electrode to undergo a first half reaction; a second liquid electrode to undergo a second half reaction; a separating membrane disposed between the first liquid electrode and the second liquid electrode; a frame to support the separating membrane; a first current collector electrically connected with the first liquid electrode; a second current collector electrically connected with the second liquid electrode; a first adhesive member that provides a binding between the first current collector and the frame; a second adhesive member that provides a binding between the second current collector and the frame: and an inter-electrode communication part in which the first liquid electrode and/or the second liquid electrode flows. The first liquid electrode and/or the second liquid electrode flowing in the inter-electrode communication part can contact the first adhesive member and/or the second adhesive member.

In another aspect, a battery according to an implementation can include a first liquid electrode to undergo a first half reaction; a second electrode to undergo a second half reaction: a separating membrane disposed between the first liquid electrode and the second liquid electrode; a frame to support the separating membrane; a first current collector electrically connected with the first liquid electrode; a second current collector electrically connected with the second liquid electrode: an inter-electrode communication part in which the first liquid electrode and/or the second liquid electrode flows; a first adhesive member that provides a binding between the frame and the first current collector to prevent the first liquid electrode or the second liquid electrode flowing in the inter-electrode communication part from contacting the first current collector: and a second adhesive member that provides a binding between the frame and the second current collector to prevent the first liquid electrode or the second liquid electrode flowing in the inter-electrode communication part from contacting the second current collector.

In another aspect, a battery according to an implementation can include a first liquid electrode to undergo a first half reaction; a second electrode to undergo a second half reaction: a separating membrane disposed between the first liquid electrode and the second liquid electrode; a frame that is configured to support the separating membrane and that forms a space in which the first liquid electrode and the second liquid electrode flow; a first solid electrode impregnated with the first liquid electrode; a second solid electrode impregnated with the second liquid electrode; a first current collector electrically connected with the first liquid electrode; a second current collector electrically connected with the second liquid electrode; a first adhesive member that provides a binding between the first current collector and the frame: and a second adhesive member that provides a binding between the second current collector and the frame. The first adhesive member and the second adhesive member can be disposed in a part of the space defined by the frame in which the first solid electrode and the second solid electrode are not disposed.

Specific details of other implementations are described along with in the section of Detailed Description and Drawings.

The battery according to the present disclosure can have one or more of the following effects.

First, the frame and the current collector can be bonded by using the adhesive member, thereby preventing the liquid electrode from leaking.

Second, the adhesive member can be disposed between the inter-electrode communication part and the current collector, thereby preventing electrochemical corrosion of the current collector due to a short circuit in the current when the liquid electrode flowing in the inter-electrode communication part contacts the current collector.

Third, the adhesive member can bind the outer peripheral portions of the frame and the outer peripheral portions of the current collector in the closed curve, thereby providing structural strength and preventing deformation of the frame and leakage of the liquid electrode.

Fourth, the inter-electrode communication part can be formed relatively evenly in the frame, thereby preventing stress concentration in specific parts and allowing the frame to be made thin to a predetermined width.

Specific effects are described along with the above-described effects in the section of Detailed Description.

Aspects according to the present disclosure are not limited to the above ones, and other aspects and advantages that are not mentioned above can be clearly understood from the following description and can be more clearly understood from the implementations set forth herein. Additionally, the aspects and advantages in the present disclosure can be realized via means and combinations thereof that are described in the appended claims.

### BRIEF DESCRIPTION OF DRAWINGS

FIG. 1 is an exploded perspective view of an example of a battery according to an implementation;

FIG. 2 is a perspective view of an example of a battery according to an implementation;

FIG. 3 is a cross sectional view of an example of the battery shown in FIG. 2 along a 3-3 direction:

FIG. 4 is a perspective view of an example of a battery module according to an implementation:

FIG. 5 is a plane view of an example of a battery according to an implementation;

FIG. 6 is a front view of an example of a frame according to an implementation;

FIG. 7 is a rear view of an example of a frame according to an implementation;

FIG. 8 is a view showing an example of flow of liquid electrode through an inter-electrode communication part of a battery according to an implementation;

FIG. 9 is a cross sectional view of an example of the frame shown in FIG. 7 along a 9-9 direction:

FIG. 10 is a cross sectional view partially showing an example of a battery according to another implementation: and

FIG. 11 is a cross sectional view partially showing an example of a battery according to a further implementation.

### DETAILED DESCRIPTION

Although a redox flow battery has advantages of long lifespan, high output and high capacity, there are problems due to space constraints and design difficulty due to a tank that stores the electrolyte and a fluid pump to flow the electrolyte. Accordingly, implementations of the present disclosure enable a redox battery that eliminated the electrolyte tank and the fluid pump, but had the problem of low energy density and large volume. To overcome the above-noted disadvantages, one objective of the present disclosure is to provide a battery that can minimize the volume of the battery.

The above-described aspects, features and advantages are specifically described hereunder with reference to the accompanying drawings such that one having ordinary skill in the art to which the present disclosure pertains can easily implement the technical spirit of the disclosure. In the disclosure, detailed descriptions of known technologies in relation to the disclosure are omitted if they are deemed to make the gist of the disclosure unnecessarily vague. Below, preferred implementations according to the disclosure are specifically described with reference to the accompanying drawings. In the drawings, identical reference numerals can denote identical or similar components.

The terms “first”, “second” and the like are used herein only to distinguish one component from another component. Thus, the components should not be limited by the terms. Moreover, a first component can be a second component unless stated to the contrary.

Throughout the disclosure, each component can be provided as a single one or a plurality of ones, unless explicitly stated to the contrary.

Hereinafter, expressions of ‘a component is provided or disposed in an upper or lower portion’ can mean that the component is provided or disposed in contact with an upper surface or a lower surface. The present disclosure is not intended to limit that other elements are provided between the components and on the component or beneath the component.

It will be understood that when an element is referred to as being “connected with” another element, the element can be directly connected with the other element or intervening elements can also be present. In contrast, when an element is referred to as being “directly connected with” another element, there are no intervening elements present.

A singular representation can include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps can likewise be utilized.

Throughout the disclosure, the terms “A and/or B” as used herein can denote A, B or A and B, and the terms “C to D” can denote C or greater and D or less, unless stated to the contrary.

Hereinafter, referring to drawings for describe a battery (e.g., a secondary battery) according to implementations of the present disclosure will be described.

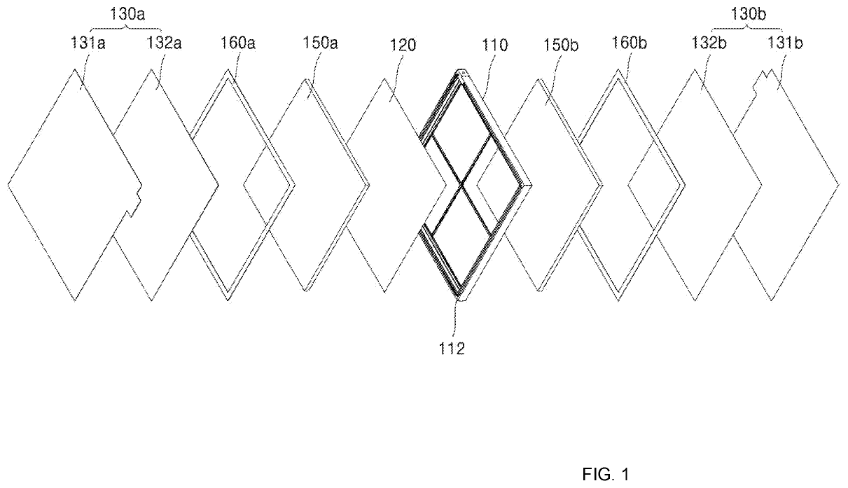

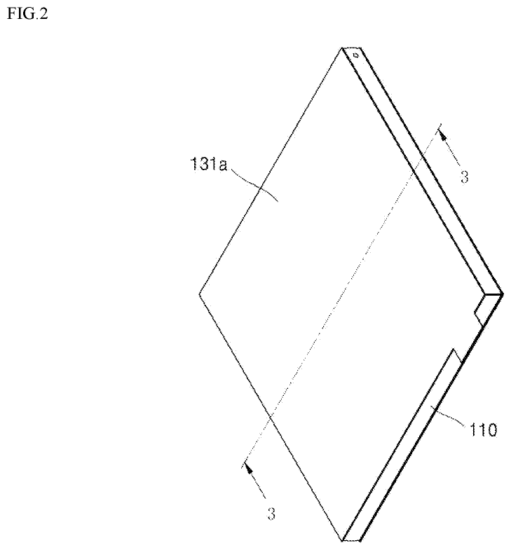

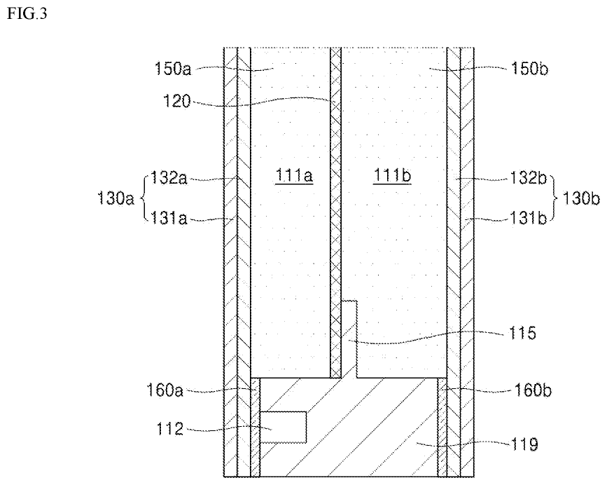

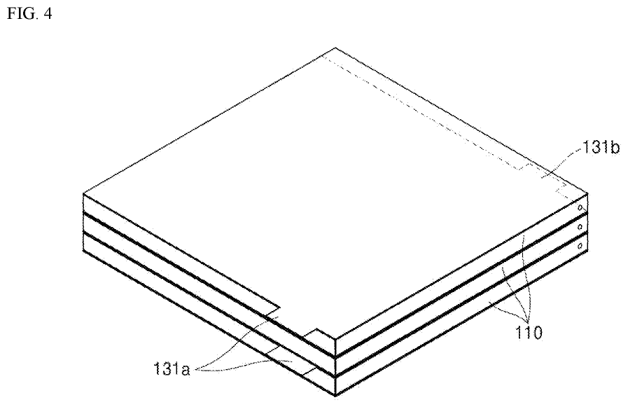

FIG. 1 is an exploded perspective view of a battery according to an implementation. FIG. 2 is a perspective view of a battery according to an implementation. FIG. 3 is a cross sectional view of the battery shown in FIG. 2 along a 3-3 direction. FIG. 4 is a perspective view of a battery module according to an implementation.

A battery according to some implementations can include a first current collector 130a; a second current collector 130b spaced apart from the first current collector 130a; a separating membrane 120 disposed between the first current collector 130a and the second current collector 130b; a frame defining a first electrode reservoir 111a and a second electrode reservoir 111b; a first liquid electrode stored in the first electrode reservoir 111a and configured to undergo a first half reaction; a second liquid electrode stored in the second electrode reservoir 111b and configured to undergo a second half reaction; a first solid electrode 150a disposed in the first electrode reservoir 111a and impregnated with the first liquid electrode; a second solid electrode 150b disposed in the second electrode reservoir 111b and impregnated with the second liquid electrode; a first adhesive member 160a that provides a binding between the first current collector 130a and the frame 110 (e.g., that binds the first current collector 130a and the frame 110 directly or indirectly to each other); a second adhesive member 160b that provides a binding between the second current collector 130b and the frame 110 (e.g., that binds the second current collector 130b and the frame 110 directly or indirectly to each other): and an inter-electrode communication part 112 to be in fluidic communication with the first electrode reservoir 111a and the second electrode reservoir 111b.

The first liquid electrode is an electrolyte in which an anode redox couple is dissolved. The anode redox couple can be realized as a material including at least one of vanadium (V), zinc (Zn), bromine (Br), chromium (Cr), manganese (Mn), titanium (Ti), iron (Fe), cerium (Ce), and cobalt (Co), and in this implementation, it is a V²⁺/V³⁺ redox couple. The first liquid electrode can be an acidic aqueous solution that conducts electric current through ionization, and preferably contains sulfuric acid. In this implementation, the first liquid electrode can be manufactured in a way that vanadylsulfate (VOSO₄) or vanadium pentoxide (V₂O₅) is dissolved in a sulfuric acid (H₂SO₄) solution.

The first liquid electrode undergoes the first half reaction. The first half reaction is as follows, and ‘→’ represents the discharge reaction direction and ‘←’ represents the charge reaction direction.

$${V}^{2 +} \text{←→} {V}^{3 +} + {e}^{-}$$

When discharging, vanadium divalent ions are oxidized to vanadium trivalent ions. When charging, vanadium trivalent ions are reduced to vanadium divalent ions.

The first liquid electrode can be surrounded by the frame 110, the first current collector 130a and the separating membrane 120. The first liquid electrode can be prevented from flowing out in the plane direction between the first current collector 130a and the frame 110 by the first adhesive member 160a. Hereinafter, the in-plane direction refers to a direction parallel to the plane formed by the separating membrane 120. The first liquid electrode can be stored in the first electrode reservoir 111a. The first liquid electrode can be impregnated into the first solid electrode 150a.

The first liquid electrode can be electrically connected with the first current collector 130a so that an electron can move to the first current collector 130a when discharging and an electron of the first current collector 130a can move to the first liquid electrode. The first liquid electrode can become in contact with the separating membrane 120 so that a hydrogen cation (proton) is moved through the separating membrane 120.

The second liquid electrode is an electrolyte in which the cathode redox couple is dissolved. The cathode redox couple can be realized as a material including at least one of vanadium (V), zinc (Zn), bromine (Br), chromium (Cr), manganese (Mn), titanium (Ti), iron (Fe), cerium (Ce), and cobalt (Co), and in this implementation, it is a V⁴⁺/V⁵⁺ redox couple. The second liquid electrode can be an acidic aqueous solution that conducts electric current through ionization, and preferably contains sulfuric acid. In this implementation, the second liquid electrode can be manufactured in a way that vanadylsulfate (VOSO4) or vanadium pentoxide (V2O5) is dissolved in a sulfuric acid (H2SO4) solution.

The second liquid electrode undergoes the second half reaction. The second half reaction is as follows, and ‘→’ represents the discharge reaction direction and ‘←’ represents the charge reaction direction.

$${V}^{5 +} + {e}^{-} \text{←→} {V}^{4 +}$$

When discharging, vanadium pentavalent ions are reduced to vanadium tetravalent ions. When charging, vanadium tetravalent ions are oxidized to vanadium pentavalent ions.

The second liquid electrode can be surrounded by the frame 110, the second current collector 130b and the separating membrane 120. The second liquid electrode can be prevented from flowing out in the plane direction between the second current collector 130b and the frame 110 by the second adhesive member 160b. The second liquid electrode can be stored in the second electrode reservoir 111b. The second liquid electrode can be impregnated into the second solid electrode 150b.

The second liquid electrode can be electrically connected with the second current collector 130b so that an electron can move to the second current collector 130b when charging and an electron of the second current collector 130b can move to the second liquid electrode. The second liquid electrode can become in contact with the separating membrane 120 so that a hydrogen cation (proton) is moved through the separating membrane 120.

As described above. The first liquid electrode and the second liquid electrode have the same component. The first liquid electrode and the second liquid electrode contain vanadium ions in an electrolyte of the same composition. Hereinafter, the first liquid electrode and the second liquid electrode are collectively referred to as liquid electrodes.

In some implementations, the frame 110 is formed as a square with a hollow interior region. According to other implementations, the frame 110 can be formed in a diamond, circle, triangle or polygon such as a pentagon, or other shapes. The frame can have a predetermined thickness in an out-of-plane direction to accommodate the first electrode reservoir 111a and the second electrode reservoir 111b. Hereinafter, the “out-of-plane” direction relative to a structure refers to a direction passing through the in-plane direction of the structure (where the “in-plane direction” is a direction parallel to the plane formed by the structure, such as separating membrane 120). The out-of-plane direction can include a through-thickness direction but in general is not limited to only to the direction perpendicular to the in-plane direction.

In some implementations, the frame 110 has an outer peripheral portion aligned with an outer peripheral portion of a first carbon current collector 132a of the first current collector 130a and an outer peripheral portion of a second carbon current collector 132b of the second current collector 130b.

The first current collector 130a can be disposed in one side of the frame 110 and the second current collector 130b can be disposed in the other side of the frame 110 in the out-of-plane direction of the frame 110. The hollow interior region of the frame 110 can be enclosed by the first current collector 130a and the second current collector 130b. The frame 110 can be disposed between the first current collector 130a and the second current collector 130b, and can prevent the first liquid electrode and the second liquid electrode from flowing (e.g., leaking out) along the in-plane direction. The frame 110 can be coupled to the first current collector 130a by the first adhesive member 160a and the second current collector 130b by the second adhesive member 160b.

The separating membrane 120 can be disposed in the hollow interior region of the frame 110. The hollow interior region of the frame 110 can be partitioned off into two spaces by the separating membrane 120. The frame 110 can be coupled to the separating membrane 120 by an adhesive member, which can be made of the same material as the first adhesive member 160a or the second adhesive member 160b.

The frame 110 can accommodate and form the first electrode reservoir 111a between the first current collector 130a and the separating membrane 120 and can accommodate and form the second electrode reservoir 111b between the second current collector 130b and the separating membrane 120.

The frame 110 can store the first liquid electrode and the second liquid electrode. The first solid electrode 150a and the second solid electrode 150b can be disposed inside the hollow interior region of the frame 110. The first adhesive member 160a can be adhered to an outer peripheral portion of the frame that faces the first current collector 130a and the second adhesive member 160b can be adhered to another outer peripheral portion of the frame 110 that faces the second current collector 130b, as shown in the example of FIG. 3.

The frame 110 can enclose and form the inter-electrode communication part 112 with the first adhesive member 160a or the second adhesive member 160b.

The inter-electrode communication part 112 can allow the first electrode reservoir 111a and the second electrode reservoir 111b be in fluidic communication with each other. The first liquid electrode and/or the second liquid electrode can flow in the inter-electrode communication part 112. In some implementations, the inter-electrode communication part 112 can include a groove portion and a through-hole portion. The groove portion can be formed along an outer peripheral portion of the frame 110. The groove portion of the inter-electrode communication part 112 can be recessed into the frame 110 in the out-of-plane direction, with a longitudinal direction of the groove along the in-plane direction. The through-hole portion of the inter-electrode communication part 112 can enable fluidic communication between the first electrode reservoir 111a and the second electrode reservoir 111b. For example, the through-hole portion of the inter-electrode communication part 112 can penetrate the frame 110 in the out-of-plane direction, with a longitudinal direction of the through-hole portion in the out-of-plane direction.

At least part of the inter-electrode communication part 112 can be enclosed and formed by the first adhesive member 160a or the second adhesive member 160b and the frame 110. In general, the inter-electrode communication part 112 can be disposed in the frame between the first adhesive member 160a and the second adhesive member 160b. For example, the inter-electrode communication part 112 can be enclosed by the first adhesive member 160a on the side of the frame 110 facing the first current collector 130a and/or can be enclosed by the second adhesive member 160b on the other side of the frame 110 facing the second current collector 130b. In some implementations, the first liquid electrode and/or the second liquid electrode flowing in the inter-electrode communication part 112 can be in contact with the first adhesive member 160a and/or the second adhesive member 160b.

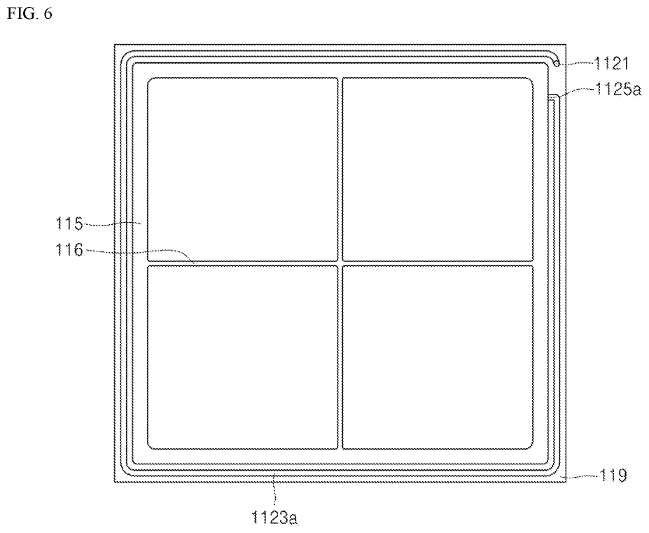

Detailed description about the inter-electrode communication part 112 will be made later, referring to FIGS. 6 through 9.

The separating membrane 120 can be disposed on the frame 110 (e.g., in the hollow interior region of the frame 110) to separate the first liquid electrode and the second liquid electrode from each other, and can allow hydrogen cations (protons) to move between the first liquid electrode and the second liquid electrode. For example, as shown in FIG. 3, the separating membrane 120 can be disposed at the center of a thickness direction of the frame 110 inside the frame 110 to separate the first electrode reservoir 111a and the second electrode reservoir 111b.

The separating membrane 120 can be disposed between the first liquid electrode and the second liquid electrode. The separating membrane 120 can be disposed between the first current collector 130a and the second current collector 130b. The separating membrane 120 can be disposed further toward an interior region of the frame 110 (in the in-plane direction) as compared to the first adhesive member 160a or the second adhesive member 160b. An outer peripheral portion of the separating membrane 120 can be bonded to the frame 110.

When discharging, hydrogen cations pass through the separating membrane 120 and move from the first liquid electrode to the second liquid electrode. When charging, they pass through the separating membrane 120 and move from the second liquid electrode to the first liquid electrode.

The separating membrane 120 can include perfluorinated ionomer, partially fluorinated polymer, and non-fluorinated hydrocarbons. The separating membrane 120 can be formed of or include Nafion®, Flemion®, NEOSEPTA-F®, or Gore Select®.

The separating membrane 120 prevents the first liquid electrode and the second liquid electrode from mixing with each other, but when charging or discharging, the vanadium ions and water contained in the first liquid electrode and the second liquid electrode might penetrate the separating membrane, which means that ‘crossover phenomenon’ might occur. Accordingly, an imbalance occurs in the amount of the first liquid electrode and the amount of the second liquid electrode, which affects the performance and lifespan of the battery. If a liquid electrode tank and a pump are provided like in the conventional redox secondary battery, this imbalance of the liquid electrodes could be resolved. However, when the small amount of liquid electrode exists only inside the battery as in the present disclosure, even small imbalance might affect the performance and lifespan of the battery. The inter-electrode communication part 112 can be configured to resolve the imbalance caused by this crossover, and can allow the first liquid electrode or second liquid electrode with an increased volume to be moved to the first liquid electrode or second liquid electrode with a reduced volume through the inter-electrode communication part.

The first current collector 130a can be disposed in one side of the frame 110 to form the first electrode reservoir 111a together with the frame 110 and the separating membrane 120. The first current collector 130a can be in parallel and spaced apart from the second current collector 130b. The first current collector 130a can be adhered to the first adhesive member 160a adhered to the frame 110. The first current collector 130a can be bonded to the frame 110 by the first adhesive member 160a. For example, the first adhesive member 160a can be applied or adhered to the outer peripheral portion of the first current collector 130a and/or to the peripheral region of the frame 110 to adhere the two together.

Since it has the first adhesive member 160a adhered thereto, the first current collector 130a may not directly contact the first liquid electrode or the second liquid electrode flowing in the inter-electrode communication part 112. The first current collector 130a can be electrically connected to the first liquid electrode and electrons can move so that current can flow when charging and discharging.

As shown in FIG. 4, in some implementations a plurality of batteries can be connected to form a module that includes a plurality of frames 110, a plurality of first current collectors 130a, and a plurality of second current collectors 130b (the examine of FIG. 4 shows an interconnection of 3 batteries). In some scenarios, the plurality of first current collectors 130a can be electrically connected (e.g., by a bus bar) to connect the plurality of batteries in parallel or series.

The first current collector 130a can include a first metal current collector 131a made of metal and electrically connected with the bus bar, and a first carbon current collector 132a can be disposed between the first metal current collector 131a and the frame 110 (as was shown in FIG. 3).

The first carbon current collector 132a can be made of a material such as graphite, carbon and carbon plastic, and can have high electrical conductivity and high acid resistance. Referring back to FIG. 3, the first carbon current collector 132a can be disposed between the first liquid electrode and the first metal current collector 131a to allow electrons to move between them, but to prevent the first metal current collector 131a from being oxidized. The first carbon current collector 132a can be formed in a rectangular plate shape or can be formed by applying the first metal current collector 131a.

The first carbon current collector 132a can be formed so that its outer peripheral portions (e.g., outer boundaries) match the outer peripheral portions (e.g., outer boundaries) of the frame 110. The first carbon current collector 132a can be bonded to the frame 110 by the first adhesive member 160a. The first carbon current collector 132a can have the first adhesive member 160a adhered or applied to its outer peripheral portions.

The first metal current collector 131a can be made of a metal with high electrical conductivity, for example, copper or aluminum. The first metal current collector 131a can be formed in a rectangular plate shape, and a part thereof can protrude to be connected to the bus bar.

The first metal current collector 131a can be formed of a flexible thin film or rigid plate. As shown in FIG. 4, when a plurality of batteries form a module, the plurality of first metal current collector 131a can be formed of a flexible thin film, with some part formed of a rigid plate.

The first carbon current collector 132a can be disposed on one surface of the first metal current collector 131a. When the plurality of batteries form the module as shown in FIG. 4, the first carbon current collector 132a of adjacent batteries on two opposite sides of a battery can be disposed on each of the two sides of the first metal current collector 131a of the battery.

Referring back to FIG. 3, the second current collector 130b can be disposed on the other side of the frame 110 to form the second electrode reservoir 111b together with the frame 110 and the separating membrane 120. The second current collector 130b can be in parallel and spaced apart from the first current collector 130a. The second current collector 130b can be adhered to the second adhesive member 160b adhered to the frame 110. The second current collector 130b can be bonded to the frame 110 by the second adhesive member 160b. For example, the second adhesive member 160b can be applied or adhered to the outer peripheral portion of the second current collector 130b and/or to the outer peripheral portion of the frame 110 to adhere the two together.

Since it has the second adhesive member 160b adhered thereto, the second current collector 130b may not directly contact the first liquid electrode or the second liquid electrode flowing in the inter-electrode communication part 112. The second current collector 130b can be electrically connected to the second liquid electrode and electrons can move so that current can flow when charging and discharging.

When the plurality of batteries form a module (e.g., as in FIG. 4) that includes the plurality of frames 110, the plurality of first current collectors 130a, and the plurality of second current collectors 130b, the plurality of second current collectors 130b can be electrically connected (e.g., by a bus bar) to connect the plurality of batteries in parallel.

The second current collector 130b can include a second metal current collector 131b made of metal and electrically connected with the bus bar; a second carbon current collector 132b disposed between the second metal current collector 131b and the frame 110.

The second carbon current collector 132b can be made of a material such as graphite, carbon and carbon plastic, and can have high electrical conductivity and high acid resistance. The second carbon current collector 132b can be disposed between the second liquid electrode and the second metal current collector 131b to allow electrons to move between them, but to prevent the second metal current collector 131b from being oxidized. The second carbon current collector 132b can be formed in a rectangular plate shape or can be formed by applying the second metal current collector 131b.

The second carbon current collector 132b can be formed so that its outer peripheral portions (e.g., outer boundaries) match the outer peripheral portions (e.g., outer boundaries) of the frame 110. The second carbon current collector 132b can be bonded to the frame 110 by the second adhesive member 160b. The second carbon current collector 132b can have the second adhesive member 160b adhered or applied to its outer peripheral portions.

The second metal current collector 131b can be made of a metal with high electrical conductivity, for example, copper or aluminum. The second metal current collector 131b can be formed in a rectangular plate shape, and a part thereof can protrude to be connected to the bus bar.

The second metal current collector 131b can be formed of a flexible thin film or rigid plate. As shown in FIG. 4, when the plurality of batteries form the module, the plurality of second metal current collector 131b can be formed of a flexible thin film, with some part formed of a rigid plate.

The second carbon current collector 132b can be disposed on one surface of the second metal current collector 131b. When the plurality of batteries form the module as shown in FIG. 4, the second carbon current collector 132b of adjacent batteries on two opposite sides of a battery can be disposed on each of the two sides of the second metal current collector 131b of the battery.

Referring back to FIG. 3, the first solid electrode 150a can be impregnated with the first liquid electrode and disposed in the first electrode reservoir 111a. The first solid electrode 150a can be surrounded by the frame 110, the first current collector 130a and the separating membrane 120. The first solid electrode 150a can include carbon-based materials such as carbon or graphite felt, carbon cloth, carbon black, graphite powder, or graphene. The first solid electrode 150a can be disposed further toward an interior of the frame 110 (in the in-plane direction) as compared to the first adhesive member 160a.

In some implementations, the first solid electrode 150a can be formed in a porous hexahedron shape. The first solid electrode 150a can have a thickness greater than the out-of-plane direction thickness of the first electrode reservoir 111a. In this case, the first solid electrode 150a can be accommodated by being pressed into the first electrode reservoir 111a. The first solid electrode 150a can be in close contact with the first current collector 130a and the separating membrane 120.

The second solid electrode 150b can be impregnated with the second liquid electrode and disposed in the second electrode reservoir 111b. The second solid electrode 150b can be surrounded by the frame 110, the second current collector 130b and the separating membrane 120. The second solid electrode 150b can include carbon-based materials such as carbon or graphite felt, carbon cloth, carbon black, graphite powder, or graphene. The second solid electrode 150b can be disposed further toward the interior of the frame 110 (in the in-plane direction) as compared to the second adhesive member 160bT.

In some implementations, the second solid electrode 150b can be formed in a porous hexahedron shape. The second solid electrode 150b can have a thickness greater than the out-of-plane direction thickness of the second electrode reservoir 111b. In this case, the second solid electrode 150b can be accommodated by being pressed into the second electrode reservoir 111b. The second solid electrode 150b can be in close contact with the second current collector 130b and the separating membrane 120.

Each of the first adhesive member 160a and the second adhesive member 160b can include at least one of an acrylate-based adhesive, an acrylate-ester-based adhesive, an acrylate-ethylene-based adhesive, a polycarbonate-based adhesive, a polyethylene-based adhesive, and an epoxy-based adhesive and an isocyanate-based adhesive. Each of the first adhesive member 160a and the second adhesive member 160b is one or a combination of a solvent-based adhesive, an emulsion-based adhesive, a hot-melt-based adhesive, a liquid-curing-based adhesive, or a film-based adhesive.

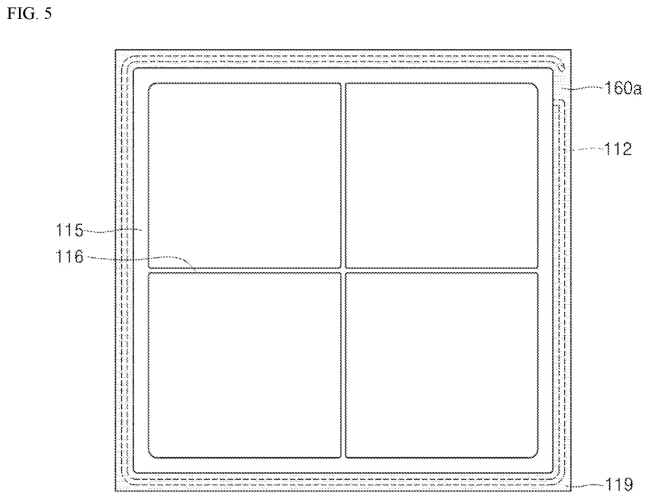

Each of the first adhesive member 160a and the second adhesive member 160b can be formed in a strip shape. For example, each of the first adhesive member 160a and the second adhesive member 160b can be formed in a square shape with a hollow interior region. In some implementations, each of the first adhesive member 160a and the second adhesive member 160b can be formed as a closed curve around a peripheral region of the frame, for example in a band shape as shown in the example of FIG. 5. In some implementations, the outer peripheral portions (e.g., outer boundaries) of each of the first adhesive member 160a and the second adhesive member 160b are formed to match the outer peripheral portions (e.g., outer boundaries) of the frame 110.

The first adhesive member 160a can bind the first carbon current collector 132a of the first current collector 130a to the frame 110. The first adhesive member 160a can seal between the first carbon current collector 132a of the first current collector 130a and the frame 110. The first adhesive member 160a can be layered between the first carbon current collector 132a of the first current collector 130a and the frame. The first adhesive member 160a can be adhered to one in-plane direction side of the frame 110. The first adhesive member 160a can be adhered to an outer peripheral portion of one surface of the first carbon current collector 132a on which the first metal current collector 131a is not disposed. The first adhesive member 160a can be applied on the first carbon current collector 132a to be adhesive to the frame 110.

The first adhesive member 160a can be disposed so that the outer peripheral portions (e.g., outer boundaries) of the first carbon current collector 132a of the first current collector 130a can match the outer peripheral portions (e.g., outer boundaries) of the frame 110. For example, the first adhesive member 160a can be disposed outside the periphery of separating membrane 120 in the frame 110 in the in-plane direction.

The first adhesive member 160a can form some part of the inter-electrode communication part 112 together with the frame 110. The first adhesive member 160a can cover some part of the inter-electrode communication part 112. The first adhesive member 160a can cover a part of the inter-electrode communication part 112 that is formed as the in-plane groove at the outer peripheral portion of the frame 110. The first adhesive member 160a can cover a part of the inter-electrode communication part 112 that is formed as a through-hole in the frame 110.

At least part of the first adhesive member 160a can extend beyond the inter-electrode communication part 112 toward the outer boundary of the frame 110. The first liquid electrode or second liquid electrode flowing in the inter-electrode communication part 112 can contact the first adhesive member 160a. The first adhesive member 160a can be adhered to the frame 110 and the first current collector 130a so that the first liquid electrode or second liquid electrode flowing in the inter-electrode communication part 112 may not contact the first current collector 130a.

The first adhesive member 160a can be disposed in a space defined by the frame 110 where the first solid electrode 150a and second solid electrode 150b are not disposed, among the spaces defined by the frame 110 (i.e., among spaces such as the first electrode reservoir 111a, the second electrode reservoir 111b, and/or the inter-electrode communication part 112).

The second adhesive member 160b can bind the second carbon current collector 132b of the second current collector 130b to the frame 110. The second adhesive member 160b can seal between the second carbon current collector 132b of the second current collector 130b and the frame 110. The second adhesive member 160b can be layered between the second carbon current collector 132b of the second current collector 130b and the frame 110. The second adhesive member 160b can be adhered to the other out-of-plane direction outer peripheral portion of the frame 110. The second adhesive member 160b can be adhered to the outer peripheral portion of one of the two surfaces of the second carbon current collector 132b, where the second metal current collector 131b is not disposed. The second adhesive member 160b can be applied to the second carbon current collector 132b to be adhesive to the frame 110.

The second adhesive member 160b can be disposed to allow the outer peripheral portions (e.g., outer boundaries) of the second carbon current collector 132b of the second current collector 130b to match the outer peripheral portions (e.g., outer boundaries) of the frame 110. The second adhesive member 160b can be disposed further toward the outer boundary of the frame 110 (in the in-plane direction) as compared to the second solid electrode 150b. The second adhesive member 160b can be disposed further toward the outer boundary of the frame 110 (in the in-plane direction) as compared to the second reservoir 111b. The second adhesive member 160b can be disposed further toward the outer boundary of the frame 110 (in the in-plane direction) as compared to the separating membrane 120S.

The second adhesive member 160b can form some part of the frame 110 and some part of the inter-electrode communication part 112. The second adhesive member 160b can cover some part of the inter-electrode communication part 112. The second adhesive member 160b can cover the part formed in the inter-electrode communication part 112 as the groove in the in-plane direction of the outer peripheral portion of the frame 110. The second adhesive member 160b can cover the part formed as the through-hole in the inter-electrode communication part 112 in the out-of-plane direction of the frame 110.

At least part of the second adhesive member 160b can extend beyond the inter-electrode communication part 112 toward the outer boundary of the frame 110. The first liquid electrode or second liquid electrode flowing in the inter-electrode communication part 112 can contact with the second adhesive member 160b. The second adhesive member 160b can be adhered to the frame 110 and the second current collector 130b so that the first liquid electrode or second liquid electrode flowing in the inter-electrode communication part 112 may not contact the second current collector 130b.

The second adhesive member 160b can be disposed in a space defined by the frame 110 (e.g., the first electrode reservoir 111a, the second electrode reservoir 111b and the inter-electrode communication part 112), where the first solid electrode 150a and second solid electrode 150b are not disposed.

The first adhesive member 160a and the second adhesive member 160b can cover both ends of the through-hole part in the inter-electrode communication part 112, respectively. One end of the through-hole in the inter-electrode communication part 112 can be blocked by the first adhesive member 160a and the other end of the through-hole in the inter-electrode communication part 112 can be blocked by the second adhesive member 160b. The liquid electrode flowing in the groove of the inter-electrode communication part 112 can be prevented from directly contacting the first carbon current collector 132a of the first current collector 130a by the first adhesive member 160a and from directly contacting the second carbon current collector 132b of the second current collector 130b by the second adhesive member 160b.

The structure of the battery having the above-noted configurations according to the present disclosure will be described as follows.

The separating membrane 120 can be bonded to the thickness-direction center of the rectangular frame 110 with a predetermined thickness. The first current collector 130a can be bonded to one out-of-plane direction side of the frame 110 by the first adhesive member 160a, and the second current collector 130b can be bonded to the other out-of-plane direction side of the frame by the second adhesive member 160b, only to form the first electrode reservoir 111a and the second electrode reservoir 111b. That is, the frame 110 can be disposed between the first current collector 130a and the second current collector 130b, and the separating membrane 120 can be disposed in the frame 110.

The first solid electrode 150a impregnated with the first liquid electrode can be disposed in the first electrode reservoir 111a, and the second solid electrode 150b impregnated with the second liquid electrode can be disposed in the second electrode reservoir 111b.

The first adhesive member 160a or the second adhesive member 160b can be adhered to the outer peripheral regions of the frame 110 to be adhered to the outer peripheral regions of the first carbon current collector 132a or the second carbon current collector 132b. The first adhesive member 160a, the second adhesive member 160b, the frame 110, the first carbon current collector 132a and the second carbon current collector 132b can be disposed to allow the outer peripheral regions (e.g., outer boundaries) thereof to match each other. Accordingly, when they are bonded to each other, the shape becomes a rectangular parallelepiped shape.

The first adhesive member 160a or second adhesive member 160b can form the frame 110 and the inter-electrode communication part 112. The first adhesive member 160a, the first carbon current collector 132a and the first metal current collector 131a can be sequentially disposed on the inter-electrode communication part 112 of the first electrode reservoir 111a. The second adhesive member 160b, the second carbon current collector 132b and the second metal current collector 131b can be sequentially disposed on the inter-electrode communication part 112 of the second electrode reservoir 111b.

When charging or discharging, the first liquid electrode and/or second liquid electrode can flow in the inter-electrode communication part 112, but can be prevented from directly contacting the first current collector 130a or second current collector 130b by the first adhesive member 160a or second adhesive member 160b.

Referring to FIG. 4, the above-described configurations are crossed and repeated to form the module. That is, the first current collector 130a can be disposed between the plurality of frames 110 to which the separating membrane 120 is bonded, and the second current collector 130b can be disposed between the plurality of frames 110 to which the separating membrane 120 is bonded. In this case, only one first metal current collector 131a can be disposed between two first carbon current collectors 132a, and only one second metal current collector 131b can be disposed between two second carbon current collector 132b.

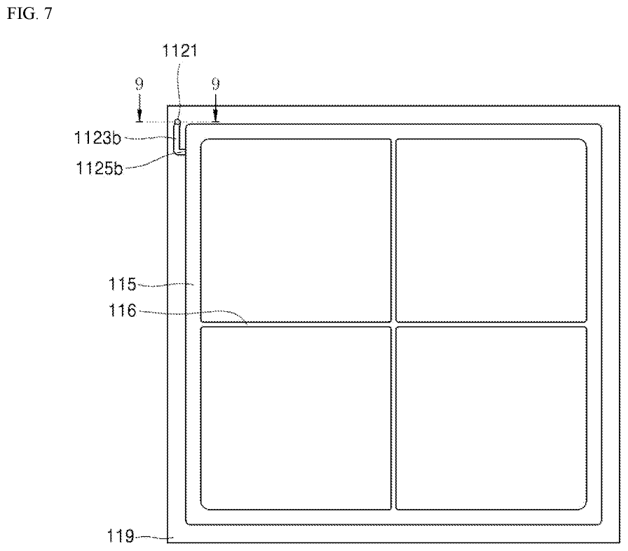

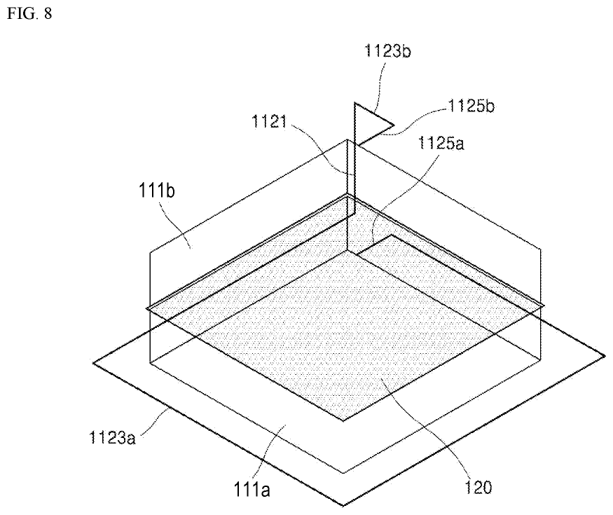

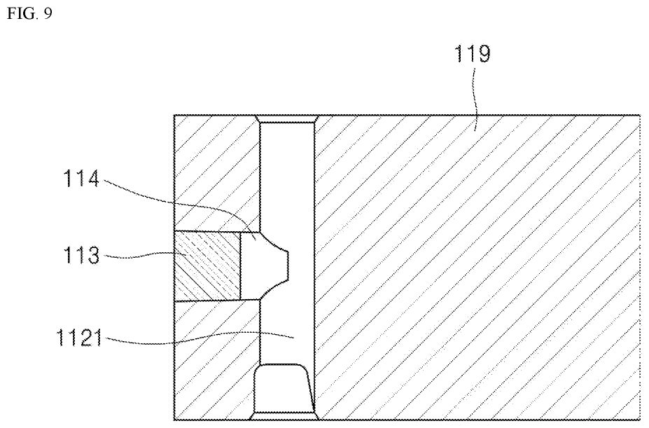

FIG. 5 is a plane view of a battery according to an implementation. FIG. 6 is a front view of a frame according to an implementation. FIG. 7 is a rear view of a frame according to an implementation. FIG. 8 is a view showing flow of liquid electrode through an inter-electrode communication part of a battery according to an implementation. FIG. 9 is a cross sectional view of the frame shown in FIG. 7 along a 9-9 direction.

The frame 110 according to an implementation of the present disclosure can include a frame body 119 having a square shape with an outer structural region that surrounds a hollow interior region; a separating membrane supporter 115 protruding inward from the outer structural region of the frame body 119 toward the hollow interior region to be bonded to the separating membrane 120; and a frame reinforcing portion 116 disposed in the hollow interior region of the frame body 119 to prevent deformation of the frame body 119.

The frame body 119 can be formed in the hollow square shape with four bars. The hollow interior region of the frame body 119 can form the first electrode reservoir 111a and the second electrode reservoir 111b. The separating membrane supporter 115 protruding in the in-plane direction can be formed in the hollow interior region of the frame body 119. The inter-electrode communication part 112 can be formed in the frame body 119.

The frame body 119 can have one out-of-plane direction side to which the first adhesive member 160a is adhered and the other out-of-plane direction side to which the second adhesive member 160b is adhered. The out-of-plane direction side of the frame body 119 can be bonded to the first current collector 130a by the first adhesive member 160a, and the other out-of-plane direction side thereof can be bonded to the second current collector 130b by the second adhesive member 160b.

The separating membrane supporter 115 can protrude toward the center in the in-plane direction from the hollow interior region of the frame body 119, and can be formed in a square shape. Referring to FIG. 3, the separating membrane supporter 115 can be disposed at the center of the frame body 119 in the thickness direction.

The outer peripheral portion of the separating membrane 120 can be bonded to the separating membrane supporter 115 so that the separating membrane can be stretched tightly. It is preferred that the separating membrane supporter 115 has a minimum width capable of supporting the separating membrane 120. The separating membrane supporter 115 can serve as a rib for reinforcing the in-plane direction of the frame body 119, to prevent the frame body 119 from being deformed in the in-plane direction even when expansion or contraction of the first or second liquid electrode, gas generation within the liquid electrode or external shock occurs.

One lateral surface of the separating membrane supporter 115 can be bonded to the separating membrane 120 in close contact, to prevent the first liquid electrode or second liquid electrode from leaking between the separating membrane supporter 115 and the separating membrane 120. An adhesive including the same component as the material of the first adhesive member 160a or second adhesive member 160b can be disposed between the between the separating membrane supporter 115 and the separating membrane 120. The separating membrane supporter 115 and the separating membrane 120 can be bonded by an adhesive including at least one of an n acrylate-based adhesive, an acrylate-ester adhesive, an acrylate-ethylene-based adhesive, a polycarbonate-based adhesive, a polyethylene-based adhesive, an epoxy-based adhesive, and an isocyanate-based adhesive.

The separating membrane supporter 115 can be disposed inside the first adhesive member 160a or second adhesive member 160b in the in-plane direction.

The frame reinforcing portion 116 can be formed to connect one side of the frame body 119 to another side or to connect one vertex to another vertex. The frame reinforcing portion 116 of this implementation can be formed in a + shape connecting two opposite sides of the frame body 119.

The frame reinforcing portion 116 can be disposed inside the first adhesive member 160a or second adhesive member 160b in the in-plane direction.

Referring to FIG. 5, the first adhesive member 160a or second adhesive member 160b may not be adhered to the separating membrane supporter 115. The first adhesive member 160a can be adhered to the out-of-plane direction side of the frame body 119, and the second adhesive member 160b can be adhered to the other out-of-plane direction side of the frame body 119. The first adhesive member 160a can cover the part of the inter-electrode communication part 112 formed on the out-of-plane direction side of the frame body 119, and the second adhesive member 160b can cover the part of the inter-electrode communication part 112 formed on the other out-of-plane direction side of the frame body 119.

To resolve the imbalance between the amount of the first liquid electrode and the amount of the second liquid electrode due to crossover that might occur when charging or discharging, the inter-electrode communication part 112 is configured to be in fluidic communication with the first electrode reservoir 111a and the second electrode reservoir 111b so that the first liquid electrode or second liquid electrode can flow inside the inter-electrode communication part, when charging or discharging.

The inter-electrode communication part 112 can be formed thin and long to have a resistance value above a predetermined level while having a volume allowing flow of as much as half the difference between the amount of the first liquid electrode and the amount of the second liquid electrode due to the crossover.

The inter-electrode communication part 112 can be formed in a part of the frame body 119 surrounding the first solid electrode 150a or second solid electrode 150b to be disposed in a part of the circumference of the first solid electrode 150a or second solid electrode 150b.

In some implementations, the inter-electrode communication part 112 can be disposed further toward the outer boundary of the frame 110 (in the in-plane direction) as compared to the separating membrane supporter 115. In some implementations, the inter-electrode communication part 112 may be disposed further inward away from the outer boundary of the frame 110 (in the in-plane direction) as compared to the adhesive member 160a or second adhesive member 160b. For example, the inter-electrode communication part 112 can be covered by the first adhesive member 160a or second adhesive member 160b.

Referring to FIGS. 5 and 6, the inter-electrode communication part 112 can include an inter-electrode through-hole 1121 formed as a through-hole in the frame in the out-of-plane direction; a first inter-electrode channel 1123a through which the inter-electrode through-hole 1121 and the first electrode reservoir 111a are in fluidic communication with each other: and a second inter-electrode channel 1123b through which the inter-electrode through-hole 112 and the second electrode reservoir 111b are in fluidic communication with each other.

The inter-electrode through-hole 1121 can be formed in the frame 110 as the out-of-plane direction through-hole. The inter-electrode through-hole 1121 can be disposed in a direction penetrating the plane formed by the separating membrane 120. The inter-electrode through-hole 1121 can be perpendicular to the plane formed by the separating membrane 120. The transition can be perpendicular to the first inter-electrode channel 1123a. The inter-electrode through-hole 1121 can be perpendicular to the second inter-electrode channel 1123b. The inter-electrode through-hole 1121 formed in the out-of-plane direction can be bent in the in-plane direction at one end to be connected to the first inter-electrode channel 1123a, and bent in the in-plane direction at the other end to be connected with the second inter-electrode channel 1123b. The inter-electrode through-hole 1121 can connect the first inter-electrode channel 1123a and the second inter-electrode channel 1123b with each other.

The inter-electrode through-hole 1121 can be formed one corner of the square-shaped frame body 119. One end of the inter-electrode through-hole 1121 can be covered by the first adhesive member 160a and the other end thereof can be covered by the second adhesive member 160b. The out-of-plane direction (i.e., longitudinal direction) center of the inter-electrode through-hole 1121 can be connected with an injection hole 114, which will be described later.

Referring to FIG. 6, the first inter-electrode channel 1123a can be formed in one out-of-plane direction side of the frame body 119 as the groove. The first inter-electrode channel 1123a can be formed along the frame body 119 as making the in-plane direction as the longitudinal direction. The first inter-electrode channel 1123a can be bent at least twice. The first inter-electrode channel 1123a can be bent four times in the inter-electrode through-hole 1121 along the shape of the frame body 119 to form a shape close to a square, and can be then connected to the first electrode reservoir 111a, to be connected with the first electrode reservoir 111a. The first inter-electrode channel 1123a can be formed on all four bars of the frame body 119. The first inter-electrode channel 1123a can have a first transition drain 1125a that is open to be connected with the first electrode reservoir 111a. The first inter-electrode channel 1123a can be covered by the first adhesive member 160a.

Referring to FIG. 7, the second inter-electrode channel 1123b can be formed as a groove formed on the other out-of-plane direction side of the frame body 119. The second inter-electrode channel 1123b can be formed along the frame body 119 as having the in-plane direction as the longitudinal direction. The second inter-electrode channel 1123b can be formed in the inter-electrode through-hole 1121 in a straight line along one of the bars of the frame body 119 and can be then connected to the second electrode reservoir 111b. The second inter-electrode channel 1123b can have a second transition drain 1125b that is open to be connected with the second electrode reservoir 111b. The second inter-electrode channel 1123b can be covered by the second adhesive member 160b.

The second inter-electrode channel 1123b can be formed not to overlap the first inter-electrode channel 1123a, when projected in the out-of-plane direction so that the first inter-electrode channel 1123a and the second inter-electrode channel 1123b can be form a closed curve when projected in the out-of-plane direction. When projected in the out-of-plane direction, the first inter-electrode channel 1123a and the second inter-electrode channel 1123b can form a square shape. That is, the first inter-electrode channel 1123a and the second inter-electrode channel 1123b can be formed throughout the longitudinal direction (i.e., in-plane direction) of the frame body 119.

The second transition drain 1125b can be formed to overlap the first transition drain 1125a when projected in the out-of-plane direction. The first transition drain 1125a and the second transition drain 1125b can be formed in the same direction, in parallel.

The first adhesive member 160a can cover the first inter-electrode channel 1123a and the second adhesive member 160b can cover the second inter-electrode channel 1123b. The first adhesive member 160a can cover one end of the inter-electrode through-hole 1121, and the second adhesive member 160b can cover the other end of the inter-electrode through-hole 1121.

Referring to FIG. 9, the battery according to an implementation of the present disclosure can further include an injection hole 114 formed in the frame 110 so that the first liquid electrode or second liquid electrode can be injected through the injection hole 114.

The injection hole 114 can be formed in the frame 110 so that the liquid electrode can be injected from the outside through the injection hole 114 to be introduced into the first electrode reservoir 111a and the second electrode reservoir 111b. The injection hole 114 can have one end that is open to the outside in the frame 110. The injection hole 114 can be formed to inject the first liquid electrode into the first electrode reservoir 111a and the second liquid electrode into the second electrode reservoir 111b. When the liquid electrode is injected from the outside through the injection hole 114, the liquid electrode can be accommodated in the first electrode reservoir 111a and the second electrode reservoir 111b. The liquid electrode injected into the first electrode reservoir 111a through the injection hole 114 can become the first liquid electrode, and the liquid electrode injected into the second electrode reservoir through the injection hole 114 can become the second liquid electrode.

The injection hole 114 can be the hole formed in the in-plane direction of the frame 110. The injection hole 114 can be formed at one end of one bar of the frame body 119 in a longitudinal direction. The injection hole 114 can be formed at one corner of the square-shaped frame body 119. The injection hole 114 can be formed at the thickness direction of the frame body 119.

The injection hole 114 can be disposed on the plane formed by the separating membrane 120. The injection hole 114 can be disposed at the boundary between the first electrode reservoir 111a and the second electrode reservoir 111b. The injection hole 114 can be disposed between the first adhesive member 160a and the second adhesive member 160b.

The injection hole 114 can have the in-plane length that is longer than the thickness of the frame 110 in the thickness direction.

It is preferable that the injection port 114 is connected at right angles to the inter-electrode through-hole 1121 of the inter-electrode communication part 112 and branched into a T shape. The injection hole 114 can be branched to the inter-electrode communication part 112 to be connected with the first electrode reservoir 111a and the second electrode reservoir 111b. The injection hole 114 can be connected with the center of the in-plane direction (i.e., the longitudinal direction) of the inter-electrode through-hole 1121. The cross-sectional flow area of the injection port 114 at any one point is larger than the maximum cross-sectional flow area of the inter-electrode communication part 112. The cross-sectional flow area of the injection port 114 decreases from one end to the other end connected to the inter-electrode through-hole 1121 of the inter-electrode communication part 112. The injection hole 114 can be disposed between the first inter-electrode channel 1123a and the second inter-electrode channel 1123b. The injection hole 114 can be formed in the same direction as the first transition drain 1125a and the second transition drain 1125b, and can be arranged in parallel. According to an implementation, the injection hole 114 can be disposed in a direction perpendicular to the first transition drain 1125a or the second transition drain 1125b.

The injection hole 114 can be closed after the liquid electrode is injected into the first electrode receiver 111a and the second electrode receiver 111b in an amount that undergoes the first half reaction and the second half reaction.

The battery according to an implementation of the present disclosure can include a sealing member 113 that blocks the injection hole 114.

At least part of the sealing member 113 can be inserted into the injection hole 114. In the implementation, the sealing member 113 can have a rod shape and can be press-fitted into the injection hole 114 to block the injection hole 114. The sealing member 113 can include at least one of an acrylate-based adhesive, an acrylate-ester-based adhesive, an acrylate-ethylene-based adhesive, a polycarbonate-based adhesive, a polyethylene-based adhesive, an epoxy-based adhesive, and an isocyanate-based adhesive. The sealing member 113 is one of solvent-based, emulsion-based, hot-melt-based, or liquid-curing-based adhesive/adhesive and can be injected into the injection hole 114 to seal the injection hole 114. The cross-sectional flow area of the injection port 114 becomes smaller from one end blocked by the sealing member 113 to the other end.

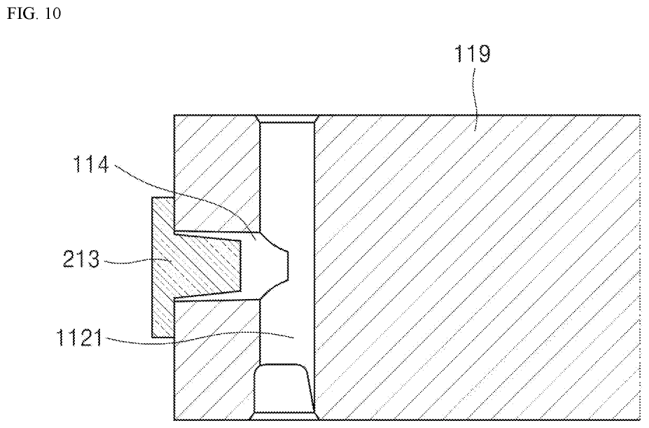

FIG. 10 is a cross sectional view partially showing a battery according to another implementation.

In the implementation, some part of the sealing member 213 can be attached to the frame 110 to cover the injection hole 114, and the other part thereof can be inserted into the injection hole 114. The sealing member 213 can be adhered to the frame 110 by at least one of an acrylate adhesive, an acrylate-ester adhesive, an acrylate-ethylene adhesive, a polycarbonate adhesive, a polyethylene adhesive, an epoxy adhesive, and an isocyanate adhesive.

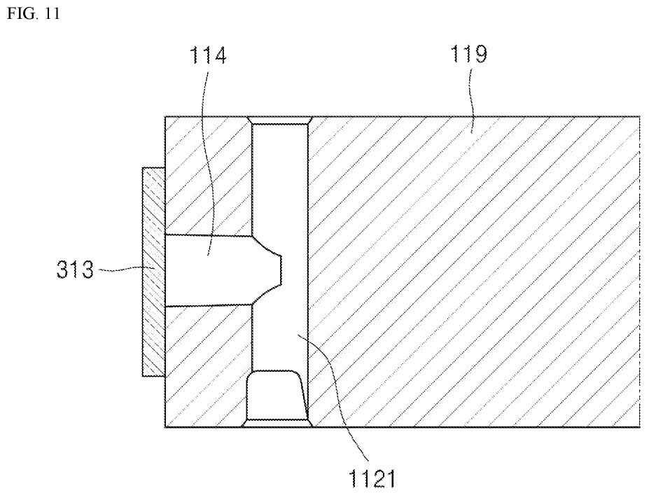

FIG. 11 is a cross sectional view partially showing a battery according to a further implementation.

In the present implementation, the sealing member 313 can be formed of a film-based adhesive and is adhered to the frame 110. The sealing member 313 includes at least one of an acrylate-based adhesive, an acrylate-ester-based adhesive, an acrylate-ethylene-based adhesive, a polycarbonate-based adhesive, a polyethylene-based adhesive, an epoxy-based adhesive, and an isocyanate-based adhesive.

The implementations are described above with reference to a number of illustrative implementations thereof. However, the present disclosure is not intended to limit the implementations and drawings set forth herein, and numerous other modifications and implementations can be devised by one skilled in the art. Further, the effects and predictable effects based on the configurations in the disclosure are to be included within the range of the disclosure though not explicitly described in the description of the implementations.

1. A battery comprising:
a first current collector;
a second current collector spaced apart from the first current collector;
a separating membrane disposed between the first current collector and the second current collector;
a frame that forms a first electrode reservoir between the first current collector and the separating membrane, and forms a second electrode reservoir between the second current collector and the separating membrane;
a first adhesive member that provides a binding between the first current collector and the frame;
a second adhesive member that provides a binding between the second current collector and the frame; and
an inter-electrode communication part configured to allow the first electrode reservoir and the second electrode reservoir to be in fluidic communication with each other,
wherein at least part of the inter-electrode communication part is enclosed by the first adhesive member and the frame or by the second adhesive member and the frame.

2. The battery of claim 1, wherein the first adhesive member seals between the first current collector and the frame, and
wherein the second adhesive member seals between the second current collector and the frame.

3. The battery of claim 1, wherein the first adhesive member is layered between the first current collector and the frame, and
wherein the second adhesive member is layered between the second current collector and the frame.

4. The battery of claim 1, wherein each of the first adhesive member and the second adhesive member comprises at least one of an acrylate adhesive, an acrylate-ester-based adhesive, an acrylate-ethylene-based adhesive, a polycarbonate-based adhesive, a polyethylene adhesive, an epoxy adhesive or an isocyanate adhesive.

5. The battery of claim 1, wherein each of the first adhesive member and the second adhesive member comprises at least one of a solvent-based adhesive, an emulsion-based adhesive, a hot-melt-based adhesive, a liquid-curing-based adhesive, or a film-based adhesive.

6. The battery of claim 1, wherein the first adhesive member is applied to at least one of the first current collector or the frame to adhere the first current collector and the frame together, and
wherein the second adhesive member is applied to at least one of the second current collector or the frame to adhere the second current collector and the frame together.

7. The battery of claim 1, wherein each of the first adhesive member and the second adhesive member forms a closed curve around a peripheral region of the frame.

8. The battery of claim 1, wherein the frame has a square shape with a hollow interior region, and
wherein each of the first adhesive member and the second adhesive member is formed in a band shape comprising outer peripheral portions that match outer peripheral portions of the frame.

9. The battery of claim 1, wherein the first adhesive member is adhered to one side of the frame, and
the second adhesive member is adhered to the other out-of-plane direction side of the frame.

10. The battery of claim 1, wherein the frame comprises,
a frame body comprising an outer structural region that surrounds a hollow interior region; and
a separating membrane supporter protruding inward from the outer structural region of the frame body toward the hollow interior region of the frame body to be bonded to the separating membrane, and
the first adhesive member is adhered to a first side of the outer structural region of the frame body that faces the first current collector, and the second adhesive member is adhered to a second side of the outer structural region of the frame body that faces the second current collector.

11. The battery of claim 1, wherein the frame comprises,
a frame body comprising an outer structural region that surrounds a hollow interior region; and
a separating membrane supporter protruding inward from the outer structural region of the frame body toward the hollow interior region of the frame body to be bonded to the separating membrane, and
each of the first adhesive member and the second adhesive member is disposed on the outer structural region of the frame body and is disposed further toward the outer boundary of the frame as compared to the separating membrane supporter.

12. The battery of claim 1, further comprising:
a first solid electrode disposed in the first electrode reservoir and configured to be impregnated with a first liquid electrode; and
a second solid electrode disposed in the second electrode reservoir and configured to be impregnated with a second liquid electrode,
wherein the first adhesive member is disposed further toward the outer boundary of the frame as compared to the first solid electrode, and
the second adhesive member is disposed further toward the outer boundary of the frame as compared to the second solid electrode.

13. The battery of claim 1, wherein each of the first adhesive member and the second adhesive member is disposed further toward the outer boundary of the frame as compared to the separating membrane.

14. The battery of claim 1, wherein the inter-electrode communication part is disposed between the first adhesive member and the second adhesive member.

15. The battery of claim 1, wherein the inter-electrode communication part comprises:
an inter-electrode through-hole that is disposed in an out-of-plane direction of the frame;
a first inter-electrode channel configured to allow the inter-electrode through-hole and the first electrode reservoir to be in fluidic communication with each other; and
a second inter-electrode channel configured to allow the inter-electrode through-hole and the second electrode reservoir to be in fluidic communication with each other,
wherein the first adhesive member covers the first inter-electrode channel, and the second adhesive member covers the second inter-electrode channel.

16. The battery of claim 1, wherein the first adhesive member is disposed further toward the outer boundary of the frame as compared to the first electrode reservoir, and
the second adhesive member is disposed further toward the outer boundary of the frame as compared to the second electrode reservoir.

17. A battery comprising:
a first current collector;
a second current collector spaced apart from the first current collector;
a separating membrane disposed between the first current collector and the second current collector;
a frame that forms a first electrode reservoir between the first current collector and the separating membrane, and forms a second electrode reservoir between the second current collector and the separating membrane;
a first adhesive member that provides a binding between the first current collector and the frame;
a second adhesive member that provides a binding between the second current collector and the frame; and
an inter-electrode communication part that allows the first electrode reservoir and the second electrode reservoir to communicate with each other,
wherein at least part of the first adhesive member and the second adhesive member are disposed further toward an outer boundary of the frame, in an in-plane direction of the frame, as compared to the inter-electrode communication part.

18. A battery comprising:
a first liquid electrode to undergo a first half reaction;
a second liquid electrode to undergo a second half reaction;
a separating membrane disposed between the first liquid electrode and the second liquid electrode;
a frame to support the separating membrane;
a first current collector electrically connected with the first liquid electrode;
a second current collector electrically connected with the second liquid electrode;
a first adhesive member that provides a binding between the first current collector and the frame;
a second adhesive member that provides a binding between the second current collector and the frame; and
an inter-electrode communication part in which the first liquid electrode and/or the second liquid electrode flows,
wherein the first liquid electrode and/or the second liquid electrode flowing in the inter-electrode communication part contact(s) the first adhesive member and/or the second adhesive member.

19. A battery comprising:
a first liquid electrode to undergo a first half reaction;
a second liquid electrode to undergo a second half reaction;
a separating membrane disposed between the first liquid electrode and the second liquid electrode;
a frame to support the separating membrane;
a first current collector electrically connected with the first liquid electrode;
a second current collector electrically connected with the second liquid electrode;
an inter-electrode communication part in which the first liquid electrode and/or the second liquid electrode flows;
a first adhesive member that provides a binding between the frame and the first current collector to prevent the first liquid electrode or the second liquid electrode flowing in the inter-electrode communication part from contacting the first current collector; and
a second adhesive member that provides a binding between the frame and the second current collector to prevent the first liquid electrode or the second liquid electrode flowing in the inter-electrode communication part from contacting the second current collector.

20. A battery comprising:
a first liquid electrode to undergo a first half reaction;
a second liquid electrode to undergo a second half reaction;
a separating membrane disposed between the first liquid electrode and the second liquid electrode;
a frame that is configured to support the separating membrane and that forms a space in which the first liquid electrode and the second liquid electrode flow;
a first solid electrode impregnated with the first liquid electrode;
a second solid electrode impregnated with the second liquid electrode;
a first current collector electrically connected with the first liquid electrode;
a second current collector electrically connected with the second liquid electrode;
a first adhesive member that provides a binding between the first current collector and the frame; and
a second adhesive member that provides a binding between the second current collector and the frame,
wherein the first adhesive member and the second adhesive member are disposed in a part of the space defined by the frame in which the first solid electrode and the second solid electrode are not disposed.
